(19) United States
(12) Patent Application Publication
(10) Pub. No.: US 2014/0026784 A1
(43) Pub. Date: Jan. 30, 2014

(54) PIGMENTED INKJET INK COMPRISING HYDROPHILIC POLYMER AS A BLEED CONTROL AGENT

(71) Applicants: Jose Esteban Valentini, West Chester, PA (US); Patricia Metzger Cotts, Wilmington, DE (US); Gregory Paul Morris, Horsham, PA (US)

(72) Inventors: Jose Esteban Valentini, West Chester, PA (US); Patricia Metzger Cotts, Wilmington, DE (US); Gregory Paul Morris, Horsham, PA (US)

(73) Assignee: E I DU PONT DE NEMOURS AND COMPANY, Wilmington, DE (US)

(21) Appl. No.: 14/111,200

(22) PCT Filed: May 29, 2012
(86) PCT No.: PCT/US2012/039816

§ 371 Date: Oct. 11, 2013

Related U.S. Application Data
(60) Provisional application No. 61/490,659, filed on May 27, 2011.

(51) Int. Cl. C09D 11/00

(52) U.S. Cl. CPC C09D 11/38
USPC 106/31.68

(57) ABSTRACT

The present disclosure provides an ink for inkjet printing. The ink contains an aqueous vehicle, a pigment and an effective amount of a hydrophilic polymer with persistence length greater than 10 nm as a bleed control agent. The ink exhibits reduced intercolor bleed when printed, for example, on plain paper.

### CROSS REFERENCE TO RELATED APPLICATIONS

This application claims priority under 35 U.S.C. §119 from U.S. Provisional Application Ser. No. 61/490,659, filed May 27, 2011.

### BACKGROUND OF THE DISCLOSURE

This disclosure pertains to an aqueous inkjet ink, in particular to an aqueous inkjet ink comprising an aqueous vehicle, a pigment colorant and a hydrophilic polymer as a bleed control agent.

Inkjet printing is a non-impact printing process in which droplets of ink are deposited on a substrate, such as paper, to form the desired image. Inkjet printers are equipped with an ink set which, for full color printing, typically comprises a cyan, magenta and yellow ink (CMY). An ink set also commonly comprises a black ink (CMYK).

Bleed of one color into another is a typical problem in ink jet printing because inks have relatively low viscosity and tend to spread especially for inkjet printers having capability of printing three or four primary colors in a simultaneous (or near simultaneous) fashion. Such bleed of one printing liquid into an adjacent printing liquid results in production of indistinct images with a poor degree of resolution.

Various methods have been proposed to prevent bleed of adjacent printing liquids. One method is to apply the two printing liquids at a distance from one another so that no intermingling or mixing of the printing liquids can occur. However, this method produces images of poor resolution. Another method involves a delay in applying the second printing liquid until the first printing liquid is completely dry. This method is disadvantageous due to its inefficiencies. Yet another approach to control bleed is to increase the rate of penetration of the printing liquid into the substrate, but this causes a reduction of optical density.

U.S. Pat. No. 5,488,402 discloses a method for preventing color bleed between two different color ink compositions wherein the first ink is anionic and comprises a coloring agent which includes one or more carboxyl and/or carboxylate groups, and the second ink includes a precipitating agent which is designed to ionically crosslink with the coloring agent in the first ink to form a solid precipitate in order to prevent bleed between the two ink compositions. Multivalent metal salts are disclosed as being useful as the precipitating agent.

U.S. Pat. No. 7,235,126 discloses an inkjet ink containing a nonionic polymer additive.

While the use of inorganic or organic salts in one or more inks of an ink set has provided improved bleed property in inkjet printing, a need still exists for inkjet ink formulations that provide good print quality without the drawbacks such as ink instability and corrosion to printhead as a result of having high concentration of salts in inks. The present disclosure satisfies this need by providing compositions having improved bleed property.

### SUMMARY OF THE DISCLOSURE

An embodiment provides an inkjet ink comprising an aqueous vehicle, a pigment colorant and a hydrophilic polymer as a bleed control agent, wherein said hydrophilic polymer has a persistence length of greater than 10 nm, provided that said hydrophilic polymer is not a biopolymer comprising guluronic acid and mannuronic acid building blocks when said pigment colorant is a self-dispersing pigment.

Another embodiment provides that the hydrophilic polymer has a persistence length of greater than 20 nm.

Another embodiment provides that the hydrophilic polymer has a persistence length of greater than 30 nm.

Another embodiment provides that the hydrophilic polymer has a persistence length of greater than 40 nm.

Another embodiment provides that the hydrophilic polymer is a polysaccharide.

Another embodiment provides that the said polysaccharide contains acid groups.

Another embodiment provides that the polysaccharide contains primary hydroxyl groups.

Another embodiment provides that the said hydrophilic polymer is DNA.

Another embodiment provides that the pigment colorant is a self-dispersing pigment.

Another embodiment provides that the pigment colorant is a self-dispersing black pigment.

Another embodiment provides that the inkjet ink further comprising a polymeric dispersant.

Yet another embodiment provides an inkjet ink set comprising a magenta, a yellow, a cyan, and a black ink comprising an aqueous vehicle, a pigment colorant and a hydrophilic polymer as a bleed control agent, wherein said hydrophilic polymer has a persistence length of greater than 10 nm, provided that said hydrophilic polymer is not a biopolymer comprising guluronic acid and mannuronic acid building blocks when said pigment colorant is a self-dispersing pigment.

These and other features and advantages of the present embodiments will be more readily understood by those of ordinary skill in the art from a reading of the following Detailed Description. Certain features of the disclosed embodiments which are, for clarity, described above and below as separate embodiments, may also be provided in combination in a single embodiment. Conversely, various features of the disclosed embodiments that are described in the context of a single embodiment, may also be provided separately or in any subcombination.

### DETAILED DESCRIPTION

Unless otherwise stated or defined, all technical and scientific terms used herein have commonly understood meanings by one of ordinary skill in the art to which this disclosure pertains.

Unless stated otherwise, all percentages, parts, ratios, etc., are by weight.

When an amount, concentration, or other value or parameter is given as either a range, preferred range or a list of upper preferable values and lower preferable values, this is to be understood as specifically disclosing all ranges formed from any pair of any upper range limit or preferred value and any lower range limit or preferred value, regardless of whether ranges are separately disclosed. Where a range of numerical values is recited herein, unless otherwise stated, the range is intended to include the endpoints thereof, and all integers and fractions within the range.

When the term “about” is used in describing a value or an end-point of a range, the disclosure should be understood to include the specific value or end-point referred to.

As used herein, the term “SDP” means a “self-dispersible” or “self-dispersing” pigment.

As used herein, the term “dispersion” means a two phase system wherein one phase consists of finely divided particles (often in a colloidal size range) distributed throughout a bulk substance, the particles being the dispersed or internal phase and the bulk substance being the continuous or external phase.

As used herein, the term “dispersant” means a surface active agent added to a suspending medium to promote uniform and maximum separation of extremely fine solid particles often of colloidal sizes. For pigments, the dispersants are most often polymeric dispersants, and the dispersants and pigments are usually combined using a dispersing equipment.

As used herein, the term “OD” means optical density.

As used herein, the term “degree of functionalization” refers to the amount of hydrophilic groups present on the surface of the SDP per unit surface area, measured in accordance with the method described further herein.

As used herein, the term “aqueous vehicle” refers to water or a mixture of water and at least one water-soluble, or partially water-soluble (i.e., methyl ethyl ketone), organic solvent (co-solvent).

As used herein, the term “substantially” means being of considerable degree, almost all.

As used herein, the term “dyne/cm” means dyne per centimetre, a surface tension unit.

As used herein, the term “cP” means centipoise, a viscosity unit.

As used herein, the term “mPa·s” means millipascal second, a viscosity unit.

As used herein, the term “mN.m⁻¹” means milliNewtons per meter, a surface tension unit.

As used herein, the term “mS.cm⁻¹” means milliSiemens per centimeter, a conductivity unit.

As used herein, the term “EDTA” means ethylenediaminetetraacetic acid.

As used herein, the term “IDA” means iminodiacetic acid.

As used herein, the term “EDDHA” means ethylenediamine-di(o-hydroxyphenylacetic acid).

As used herein, the term “DHEG” means dihydroxyethylglycine.

As used herein, the term “DTPA” means diethylenetriamine-N,N,N′,N″,N″-pentaacetic acid.

As used herein, the term “GEDTA” means glycoletherdiamine-N,N,N′,N′-tetraacetic acid.

As used herein, Surfynol® 465 is a surfactant from Air Products (Allentown, Pa., U.S.A.).

As used herein, the term “RMSD” refers to root mean square deviation.

As used herein, the term “jettability” means good jetting properties with no clogging or deflection during printing.

As used herein, the term “persistence length” is a basic mechanical property quantifying the stiffness of a long polymer.

Unless otherwise noted, the above chemicals were obtained from Aldrich (Milwaukee, Wis., U.S.A.) or other similar suppliers of laboratory chemicals.

The materials, methods, and examples herein are illustrative only except as explicitly stated, and are not intended to be limiting.

### Aqueous Vehicle

Selection of a suitable aqueous vehicle mixture depends on requirements of the specific application, such as the desired surface tension and viscosity, the selected colorant, drying time of the ink, and the type of substrate onto which the ink will be printed. Representative examples of water-soluble organic solvents which may be utilized in the present disclosure are those that are disclosed in U.S. Pat. No. 5,085,698.

If a mixture of water and a water-soluble solvent is used, the aqueous vehicle typically will contain about 30% to about 95% of water with the remaining balance (i.e., about 70% to about 5%) being the water-soluble solvent. Compositions of the present disclosure may contain about 60% to about 95% water, based on the total weight of the aqueous vehicle.

The amount of aqueous vehicle in the ink is typically in the range of about 70% to about 99.8%; specifically about 80% to about 99.8%, based on total weight of the ink.

The aqueous vehicle can be made to be fast penetrating (rapid drying) by including surfactants or penetrating agents such as glycol ether(s) or 1,2-alkanediols. Suitable surfactants include ethoxylated acetylene diols (e.g., Surfynols® series from Air Products), ethoxylated primary (e.g., Neodol® series from Shell) and secondary (e.g., Tergitol® series from Union Carbide) alcohols, sulfosuccinates (e.g., Aerosol® series from Cytec), organosilicones (e.g., Silwet® series from Witco) and fluoro surfactants (e.g., Zonyl® series from DuPont).

The amount of glycol ether(s) or 1,2-alkanediol(s) added must be properly determined, but is typically in a range of from about 1% to about 15% by weight, and more typically about 2% to about 10% by weight, based on the total weight of the ink. Surfactants may be used, typically in an amount of from about 0.01% to about 5%, and specifically from about 0.2% to about 2%, based on the total weight of the ink.

### Pigments

The term “pigment” as used herein means an insoluble colorant that requires to be dispersed with a dispersant and processed under dispersive conditions in the presence of a dispersant. The colorant also includes dispersed dyes. The dispersion process results in a stable dispersed pigment.

The selected pigment(s) may be used in dry or wet form. For example, pigments are usually manufactured in aqueous media, and the resulting pigments are obtained as a water-wet presscake. In presscake form, the pigment does not agglomerate to the extent it would in dry form. Thus, pigments in water-wet presscake form do not require as much mixing energy to de-agglomerate in the premix process as pigments in dry form. Representative commercial dry pigments are listed in U.S. Pat. No. 5,085,698.

Some examples of pigments with coloristic properties useful in inkjet inks include: cyan pigments from Pigment Blue 15:3 and Pigment Blue 15:4; magenta pigments from Pigment Red 122 and Pigment Red 202; yellow pigments from Pigment Yellow 14, Pigment Yellow 95, Pigment Yellow 110, Pigment Yellow 114, Pigment Yellow 128 and Pigment Yellow 155; red pigments from Pigment Orange 5, Pigment Orange 34, Pigment Orange 43, Pigment Orange 62, Pigment Red 17, Pigment Red 49:2, Pigment Red 112, Pigment Red 149, Pigment Red 177, Pigment Red 178, Pigment Red 188, Pigment Red 255 and Pigment Red 264; green pigments from Pigment Green 1, Pigment Green 2, Pigment Green 7 and Pigment Green 36; blue pigments from Pigment Blue 60, Pigment Violet 3, Pigment Violet 19, Pigment Violet 23, Pigment Violet 32, Pigment Violet 36 and Pigment Violet 38; white pigments such as TiO₂ and ZnO; and black pigment carbon black. The pigment names and abbreviations used herein are the “C.I.” designation for pigments established by Society of Dyers and Colourists, Bradford, Yorkshire, UK and published in The Color Index, Third Edition, 1971.

The pigment of the present disclosure can also be a self-dispersing (or self-dispersible) pigment. The term self-dispersing pigment (or “SDP”) refers to pigment particles whose surface has been chemically modified with hydrophilic, dispersability-imparting groups that allow the pigment to be stably dispersed in an aqueous vehicle without a separate dispersant. “Stably dispersed” means that the pigment is finely divided, uniformly distributed and resistant to particle growth and flocculation.

The SDPs may be prepared by grafting a functional group or a molecule containing a functional group onto the surface of the pigment, by physical treatment (such as vacuum plasma), or by chemical treatment (for example, oxidation with ozone, hypochlorous acid or the like). A single type or a plurality of types of hydrophilic functional groups may be bonded to one pigment particle. The hydrophilic groups are carboxylate or sulfonate groups which provide the SDP with a negative charge when dispersed in aqueous vehicle. The carboxylate or sulfonate groups are usually associated with monovalent and/or divalent cationic counter-ions. Methods of making SDPs are well known and can be found, for example, in U.S. Pat. No. 5,554,739 and U.S. Pat. No. 6,852,156.

The SDPs may be black, such as those based on carbon black, or may be colored pigments. Examples of pigments with coloristic properties useful in inkjet inks include: Pigment Blue 15:3 and Pigment Blue 15:4 (for cyan); Pigment Red 122 and Pigment Red 202 (for magenta); Pigment Yellow 14, Pigment Yellow 74, Pigment Yellow 95, Pigment Yellow 110, Pigment Yellow 114, Pigment Yellow 128 and Pigment Yellow 155 (for yellow); Pigment Orange 5, Pigment Orange 34, Pigment Orange 43, Pigment Orange 62, Pigment Red 17, Pigment Red 49:2, Pigment Red 112, Pigment Red 149, Pigment Red 177, Pigment Red 178, Pigment Red 188, Pigment Red 255 and Pigment Red 264 (for red); Pigment Green 1, Pigment Green 2, Pigment Green 7 and Pigment Green 36264 (for green); Pigment Blue 60, Pigment Violet 3, Pigment Violet 19, Pigment Violet 23, Pigment Violet 32, Pigment Violet 36 and Pigment Violet 38 (for blue); and carbon black. However, some of these pigments may not be suitable for preparation as SDP. Colorants are referred to herein by their “C.I.”.

The SDPs of the present disclosure may have a degree of functionalization wherein the density of anionic groups is less than about 3.5 μmoles per square meter of pigment surface (3.5 μmol/m²), and more specifically, less than about 3.0 μmol/m². Degrees of functionalization of less than about 1.8 μmol/m², and more specifically, less than about 1.5 μmol/m², are also suitable and may be preferred for certain specific types of SDPs.

The range of useful particle size after dispersion is typically from about 0.005 micrometers to about 15 micrometers. Typically, the pigment particle size should range from about 0.005 micrometers to about 5 micrometers; and, specifically, from about 0.005 micrometers to about 1 micrometers. The average particle size as measured by dynamic light scattering is less than about 500 nm, typically less than about 300 nm.

The amount of pigment present in the ink is typically in the range of from about 0.1% to about 25% by weight, and more typically in the range of from about 0.5% to about 10% by weight, based on the total weight of ink. If an inorganic pigment is selected, the ink will tend to contain higher percentages by weight of pigment than with comparable inks employing organic pigment, since inorganic pigments generally have higher densities than organic pigments.

### Polymeric Dispersant

The polymeric dispersant for the non-self-dispersing pigment(s) may be a random or a structured polymer. Typically, the polymer dispersant is a copolymer of hydrophobic and hydrophilic monomers. The “random polymer” means polymers where molecules of each monomer are randomly arranged in the polymer backbone. For a reference on suitable random polymeric dispersants, see: U.S. Pat. No. 4,597,794. The “structured polymer” means polymers having a block, branched, graft or star structure. Examples of structured polymers include AB or BAB block copolymers such as the ones disclosed in U.S. Pat. No. 5,085,698; ABC block copolymers such as the ones disclosed in EP Patent Specification No. 0556649; and graft polymers such as the ones disclosed in U.S. Pat. No. 5,231,131. Other polymeric dispersants that can be used are described, for example, in U.S. Pat. No. 6,117,921, U.S. Pat. No. 6,262,152, U.S. Pat. No. 6,306,994 and U.S. Pat. No. 6,433,117.

### Bleed Control Agent

The inventors find that highly hydrophilic, water-soluble polymers having persistence length greater than 10 nm can function as a bleed control agent in an ink. Persistence length is a measure of the conformational flexibility of a polymer. Polymers having high persistence have decreased conformational flexibility and a “rod like” geometry instead of a “coil like” geometry. Conventional polymeric bleed control agents typically have a persistence length of less than 10 nm. An aqueous ink containing a hydrophilic polymer with persistence length greater than 10 nm typically has low viscosity. When the ink is printed, the viscosity increases as the ink dries and the polymer chains align themselves. The increase in viscosity prevents the polymer and pigment particles from diffusing into the printed media or adjacent printed ink(s) when used in an ink set, thus resulting in improvement in bleed.

Typically, bleed control agents of the present disclosure include polysaccharides and DNA with persistence length greater than 10 nm. More typically, the polysaccharides contain acid groups and/or primary hydroxyl groups.

The bleed control agent is included in the ink in an effective amount to control bleed relative to the same ink without the bleed control agent. Typically, the bleed control agent is present in an ink at a level of at least about 0.2% by weight based on the total weight of the ink. The upper level is not limited, but is dictated by considerations such as compatibility with other ink components. In one embodiment, the bleed control agent is present in a range of 0.1% to 5% based on the total weight of the ink. In another embodiment, the bleed control agent is present in a range of 0.2% to 4% based on the total weight of the ink. The appropriate levels of bleed control agent can be readily determined by one of ordinary skill in the art through routine experimentation.

### Other Additives

Other ingredients, additives, may be formulated into the inkjet ink, to the extent that such other ingredients do not interfere with the stability and jettability of the inkjet ink. This may be readily determined by routine experimentation by one skilled in the art.

Surfactants are commonly added to inks to adjust surface tension and wetting properties. Suitable surfactants include the ones disclosed in the Vehicle section above. Surfactants are typically used in amounts up to about 5% and more typically in amounts up to 2% by weight, based on the total weight of the ink.

Inclusion of sequestering (or chelating) agents such as ethylenediaminetetraacetic acid (EDTA), iminodiacetic acid (IDA), ethylenediamine-di(o-hydroxyphenylacetic acid) (EDDHA), nitrilotriacetic acid (NTA), dihydroxyethylglycine (DHEG), trans-1,2-cyclohexanediaminetetraacetic acid (CyDTA), diethylenetriamine-N,N,N′,N″,N″-pentaacetic acid (DTPA), and glycoletherdiamine-N,N,N′,N′-tetraacetic acid (GEDTA), and salts thereof, may be advantageous, for example, to eliminate deleterious effects of heavy metal impurities.

Polymers may be added to the ink to improve durability or other properties. The polymers can be soluble in the vehicle or in a dispersed form, and can be ionic or nonionic. Soluble polymers include linear homopolymers and copolymers or block polymers. They also can be structured polymers including graft or branched polymers, stars and dendrimers. The dispersed polymers may include, for example, latexes and hydrosols. The polymers may be made by any known process including, but not limited to, free radical, group transfer, ionic, condensation and other types of polymerization. They may be made by a solution, emulsion, or suspension polymerization process. Typical classes of polymer additives include anionic acrylic, styrene-acrylic and polyurethane polymer.

When a polymer is present, its level is typically between about 0.01% and about 3% by weight, based on the total weight of an ink. The upper limit is dictated by ink viscosity or other physical limitations.

### Ink Sets

The term “ink set” refers to all the individual inks or other fluids an inkjet printer is equipped to jet. Ink sets typically comprise at least three differently colored inks. For example, a cyan (C), magenta (M) and yellow (Y) ink forms a CMY ink set. More typically, an ink set includes at least four differently colored inks, for example, by adding a black (K) ink to the CMY ink set to form a CMYK ink set. The magenta, yellow and cyan inks of the ink set are typically aqueous inks, and may contain dyes, pigments or combinations thereof as the colorant. Such other inks are, in a general sense, well known to those of ordinary skill in the art.

In addition to the typical CMYK inks, an ink set may further comprise one or more “gamut-expanding” inks, including differently colored inks such as an orange ink, a green ink, a red ink and/or a blue ink, and combinations of full strength and light strength inks such as light cyan and light magenta. Such other inks are, in a general sense, known to one skilled in the art.

A typical ink set comprises a magenta, yellow, cyan and black ink, wherein the black ink is an ink according to the present disclosure comprising an aqueous vehicle and a self-dispersing carbon black pigment. Specifically, the colorant in each of the magenta, yellow and cyan inks is a dye.

### Ink Properties

Jet velocity, separation length of the droplets, drop size and stream stability are greatly affected by the surface tension and the viscosity of the ink. Pigmented ink jet inks typically have a surface tension in the range of about 20 dyne/cm to about 70 dyne/cm at 25° C. Viscosity can be as high as 30 cP at 25° C., but is typically somewhat lower. The ink has physical properties compatible with a wide range of ejecting conditions, i.e., driving frequency of the piezo element or ejection conditions for a thermal head for either a drop-on-demand device or a continuous device, and the shape and size of the nozzle. The inks should have excellent storage stability for long periods so as not to clog to a significant extent in an ink jet apparatus. Furthermore, the ink should not corrode parts of the ink jet printing device it comes in contact with, and it should be essentially odorless and non-toxic.

Although not restricted to any particular viscosity range or printhead, the inventive ink set is particularly suited to lower viscosity applications such as those required by thermal printheads. Thus the viscosity of the inventive inks at 25° C. can be less than about 7 cP, typically less than about 5 cP, and more typically than about 3.5 cP. Thermal inkjet actuators rely on instantaneous heating/bubble formation to eject ink drops and this mechanism of drop formation generally requires inks of lower viscosity.

### Substrate

The present embodiments are particularly advantageous for printing on plain paper, such as common electrophotographic copier paper and photo paper, glossy paper and similar papers used in inkjet printers.

### EXAMPLES

Inks were prepared by stirring the indicated ingredients together and filtering the resulting mixture. The water used in the following Examples was deionized unless otherwise stated.

### Dispersion 1

Carbon black (S-160 from Evonik Degussa) was oxidized with ozone according to the process described in U.S. Pat. No. 6,852,156 to create carboxylic acid groups directly attached to the carbon black pigment surface. Potassium hydroxide was used to neutralize the treated pigment and convert the surface acid groups to the potassium salt form. The neutralized mixture was purified by an ultra-filtration to remove free acids, salts, and contaminants. It was further purified by washing repeatedly with de-ionized water until the conductivity of the mixture leveled off and remained relatively constant. After recovery, Dispersion 1 was a 20.5% by weight dispersion of self-dispersing carbon black pigment.

### Paper

The papers used were Canon GF500 (from Canon Inc.), Canon Extra (from Canon Inc.) and Business 4200 (from Xerox Corporation). They are referred to as “Canon GF500”, “Canon Extra” and “Xerox 4200”, respectively. Canon Extra is an all-purpose paper whereas Canon GF500 and Xerox 4200 are more suitable for inkjet printing.

### Estimation of Persistence Lengths of Various Water-Soluble Polymers

Polymers were characterized in dilute solution using size exclusion chromatography (SEC) with multi-angle light scattering (MALS). The instrument used was a Waters Alliance 2690 solvent delivery system with auto-injector. Columns were TSK-M-PW_{XL} and the mobile phase was phosphate buffered saline (PBS). The detectors utilized were a Waters 410 differential refractometer and a Wyatt Technology 18 angle HELEOS light scattering photometer. For each polymer, 150 of a dilute solution (1-10 mg/mL, depending on polymer) was injected. Data from the differential refractometer and light scattering photometer were acquired using Astra V software from Wyatt Technology. The differential refractive index increment, dn/dc, for each polymer was determined by integrating the refractive index peak and comparing with the known amount injected. In all cases, the values of dn/dc thus obtained were in good agreement with literature data for these polymers.

The MALS data enables determination of the molecular weight M at each elution volume without any column calibration, using standard light scattering equations. The reduction in scattering intensity as a function of scattering angle enables determination of the root-mean-square radius of gyration, R_{g}, at each elution volume. The persistence length can then be determined using the well-known equation:

$${R}_{G}^{2} = \frac{ρ L}{3} - {ρ}^{2} + ( \frac{2 {ρ}^{3}}{L} ) \{ 1 - \frac{ρ}{L} \text{?} - exp ( - L / ρ \text{?} \\ \text{?} \text{indicates text missing or illegible when filed}$$

where L is the contour length, and ρ is the persistence length. The contour length L was determined as M/M_{L}, where the mass per unit length, M_{L} was determined from literature values.

### Optical Density

Inks were printed with a Canon PIXMA iP4200 printer onto the above indicated papers. The coverage that an inkjet printer puts down on a substrate is usually controlled by the printer software and can be set in the printer settings. Printing was done in the selected standard print mode that targets 100% coverage. This setting for 100% coverage means that the inkjet printer is to fire enough droplets/dots to cover at least 100% of the area being printed. This usually results in dots spreading and partially overlapping with each other. The reported optical density (OD) values for areas printed at 100% coverage were measured with a Gretag Macbeth Spectrolino spectrometer manufactured by Gretag-Macbeth AG, Regensdorf, Switzerland.

### Evaluation of Bleed

Two test patterns were made on the same sheet of paper. In the first pattern, a similar horizontal black line abuts, on both the upper and lower edges, a solid block of yellow color (referred to as black on yellow and abbreviated as K/Y). In the second pattern, a horizontal black line similar that in the first two patterns abuts, on both the upper and lower edges, a solid block of red (yellow plus magenta) color (referred to as black on red and abbreviated as K/R).

The edge acuity of the black line in each of the two patterns was then assessed by image analysis under a microscope. A monochrome camera coupled to a microscope captured a digital photomicrograph of the line. The borders of the upper and lower edges were determined by analysis of the threshold reflectivity values. The points in each border were used to calculate a straight line representing the least squares best fit of the line edge. For each edge, the root mean square deviation (RMSD) of the points in the border was calculated (in units of microns, μ) relative to the least squares best fit straight line. Sufficient quantity and location of points were sampled on a given sheet to ensure that the analysis of line edges was statistically significant. RMSD relates to the perception of line edge acuity. A line with a small RMSD appears sharp upon visual inspection, whereas a line with a large RMSD appears “fuzzy” or “ragged”. This method objectively measures the relative sharpness (or raggedness) of a line printed under different conditions.

The unevenness of the K/Y line edge (RMSD K/Y) or K/R line edge (RMSD K/R) is a measure of “bleed” of the black into the yellow or red ink. Thus “bleed”, as referred to herein, correlates to the value of the K/Y line as RMSD K/Y, and the value of the K/R line as RMSD K/R. An increase in bleed is reflected by the increase in the value of RMSD K/Y or RMSD K/R.

The test patterns were printed with a Canon PIXMA iP4200 printer. The black inks used to make the horizontal line are described in the Examples. The yellow and magenta inks used to make the yellow and red blocks of color were Canon CLI-8Y and CLI-8M commercial inks made for the PIXMA iP4200 printer.

The RMSD may vary greatly from one brand of paper to another. Sometimes, there is substantial variation even within the same brand from one ream of paper to another. Day to day environmental variation (e.g., temperature, humidity) can also cause variability. To minimize such variability, all tests in a given series are run on the same day with paper from the same ream and the results are averaged from four test patterns on four different sheets of paper.

### Example 1

Inks 1A-1E were prepared using the ingredients listed in Table 1A below. Ink 1B was a control ink without the presence of any bleed control agent. Ink 1A contained 0.01% of a hydrophilic polymer Xanthan gum, supplied by Sigma Aldrich. Xanthan gum had a persistence length of 40˜100 nm. Inks 1C-1D were comparative inks containing various amounts of a polysaccharide Dextran, supplied by Sigma Aldrich. Dextran had a persistence length of 0.5 nm.

TABLE 1A

| | | Ink 1B | Ink 1C | Ink 1D |
|---|---|---|---|---|
| | Ink 1A | (control) | (comparative) | (comparative) |
| Ingredients | | | | |
| Dispersion 1* | 3.3 | 3.3 | 3.3 | 3.3 |
| (SDP) | | | | |
| 1,3-Propanediol* | 6 | 11 | 11 | 11 |
| Ethoxylated | 1 | 3 | 3 | 3 |
| glycerol* | | | | |
| Surfynol ® 465* | 0.237 | 0.25 | 0.18 | 0.18 |
| Xanthan gum* | 0.01 | — | — | — |
| Polysaccharide | — | — | 0.4 | 1.0 |
| Dextran* | | | | |
| DI Water | Balance | Balance | Balance to | Balance to |
| | to | 100% | 100% | 100% |
| | 100% | | | |
| Physical | | | | |
| Properties | | | | |
| Viscosity | 2.72 | 2.10 | 2.18 | 2.40 |
| (mPa · s) | | | | |
| pH | 7.26 | 7.53 | 7.38 | 7.42 |
| Surface Tension | 40.42 | 39.70 | 39.76 | 39.76 |
| (dyne/cm) | | | | |
| Conductivity | 0.23 | 0.14 | 0.18 | 0.18 |
| (mS/cm) | | | | |

*as % by weight based on total weight of ink

As shown in the Table 1B below, addition of Xanthan gum, a hydrophilic polymer with persistence length of 40˜100 nm, to an ink significantly reduced bleed (smaller K/Y and K/R bleed values) as compared to the same ink without the polymer (Ink 1B) or inks containing different quantities of a polymer (polysaccharide Dextran) with short persistence length (Inks 1C and 1D) on Xerox 4200 and Canon GF500 papers. The Xanthan gum additive appeared to have less impact on an ink when printed on Canon Extra paper.

TABLE 1B

| | | Ink 1B | Ink 1C | Ink 1D |
|---|---|---|---|---|
| | Ink 1A | (control) | (comparative) | (Comparative) |
| Print Properties | | | | |
| on Xerox 4200 | | | | |
| Bleed K/Y* | 49 | 60 | 81 | 94 |
| Bleed K/R* | 65 | 67 | 94 | 110 |
| Optical Density | 1.47 | 1.45 | 1.48 | 1.43 |
| Print Properties | | | | |
| On Canon GF500 | | | | |
| Bleed K/Y* | 104 | 141 | 167 | 194 |
| Bleed K/R* | 153 | 176 | 192 | 211 |
| Optical Density | 1.51 | 1.53 | 1.49 | 1.48 |
| Print Properties | | | | |
| On Canon Extra | | | | |
| Bleed K/Y* | 45 | 38 | 60 | 57 |
| Bleed K/R* | 70 | 33 | 69 | 79 |
| Optical Density | 1.29 | 1.31 | 1.27 | 1.20 |

*micrometers

### Example 2

Inks 2A-2D were prepared using the ingredients listed in Table 2A below. Inks 2A and 2B contained various amounts of a hydrophilic polymer, a DNA from salmon, supplied by Sigma Aldrich. This DNA from salmon had a persistence length of 40 nm. Inks 2D was a comparative ink containing pectin, a polysaccharide from apple, supplied by Sigma Aldrich. Pectin had a persistence length of 10 nm.

TABLE 2A

| | | | Ink 2C | Ink 2D |
|---|---|---|---|---|
| | Ink 2A | Ink 2B | (control) | (comparative) |
| Ingredients | | | | |
| Dispersion 1* (SDP) | 3.3 | 3.3 | 3.3 | 3.3 |
| 1,3-Propanediol* | 8 | 6 | 11 | 6 |
| Ethoxylated glycerol* | 2 | 1 | 3 | 1 |
| Surfynol ® 465* | 0.23 | 0.22 | 0.25 | 0.22 |
| DNA (Salmon)* | 0.1 | 0.3 | — | — |
| Pectin* | — | — | — | 0.1 |
| DI Water | Balance | Balance to | Balance to | Balance to |
| | to 100% | 100% | 100% | 100% |
| Physical Properties | | | | |
| Viscosity (mPa · s) | 2.44 | 3.89 | 2.10 | 3.59 |
| pH | 7.29 | 7.43 | 7.53 | 7.72 |
| Surface Tension | 40.37 | 39.17 | 39.70 | 39.69 |
| (dyne/cm) | | | | |
| Conductivity (mS/cm) | 0.21 | 0.23 | 0.14 | 0.38 |

*as % by weight based on total weight of ink

As shown in the Table 2B below, with the exception of when Ink 2A was printed on Canon Extra paper, both Inks 2A and 2B containing a polymer with persistence length greater than 10 nm significantly improved bleed when compared to the control ink (Ink 2C) and the comparative ink (Ink 2D).

TABLE 2B

| | | | Ink 2C | Ink 2D |
|---|---|---|---|---|
| | Ink 2A | Ink 2B | (control) | (comparative) |
| Print Properties | | | | |
| on Xerox 4200 | | | | |
| Bleed K/Y* | 40 | 17 | 38 | 17 |
| Bleed K/R* | 62 | 36 | 52 | 66 |
| Optical Density | 1.46 | 1.32 | 1.39 | 1.45 |
| Print Properties | | | | |
| On Canon GF500 | | | | |
| Bleed K/Y* | 103 | 24 | 138 | 116 |
| Bleed K/R* | 116 | 47 | 117 | 157 |
| Optical Density | 1.51 | 1.32 | 1.50 | 1.51 |
| Print Properties | | | | |
| On Canon Extra | | | | |
| Bleed K/Y* | 61 | 24 | 30 | 41 |
| Bleed K/R* | 59 | 35 | 41 | 37 |
| Optical Density | 1.27 | 1.15 | 1.24 | 1.32 |

*micrometers

What is claimed is:

1. An inkjet ink comprising an aqueous vehicle, a pigment colorant and a hydrophilic polymer as a bleed control agent, wherein said hydrophilic polymer has a persistence length of greater than 10 nm, provided that said hydrophilic polymer is not a biopolymer comprising guluronic acid and mannuronic acid building blocks when said pigment colorant is a self-dispersing pigment.

2. The ink of claim 1, wherein said hydrophilic polymer has a persistence length of greater than 20 nm.

3. The ink of claim 2, wherein said hydrophilic polymer has a persistence length of greater than 30 nm.

4. The ink of claim 3, wherein said hydrophilic polymer has a persistence length of greater than 40 nm.

5. The ink of claim 1, wherein said hydrophilic polymer is a polysaccharide.

6. The ink of claim 5, wherein said polysaccharide contains acid groups.

7. The ink of claim 5, wherein said polysaccharide contains primary hydroxyl groups.

8. The ink of claim 1, wherein said hydrophilic polymer is DNA.

9. The ink of claim 1, wherein said pigment colorant is a self-dispersing pigment.

10. The ink of claim 9, wherein said pigment colorant is a self-dispersing black pigment.

11. The ink of claim 1, further comprising a polymeric dispersant.

12. An inkjet ink set comprising a magenta, a yellow, a cyan, and a black ink comprising an aqueous vehicle, a pigment colorant and a hydrophilic polymer as a bleed control agent, wherein said hydrophilic polymer has a persistence length of greater than 10 nm, provided that said hydrophilic polymer is not a biopolymer comprising guluronic acid and mannuronic acid building blocks when said pigment colorant is a self-dispersing pigment.

13. The inkjet ink set of claim 12, wherein said hydrophilic polymer has a persistence length of greater than 20 nm.

14. The inkjet ink set of claim 13, wherein said hydrophilic polymer has a persistence length of greater than 30 nm.

15. The inkjet ink set of claim 14, wherein said hydrophilic polymer has a persistence length of greater than 40 nm.

16. The inkjet ink set of claim 12, wherein said hydrophilic polymer is a polysaccharide.

17. The inkjet ink set of claim 16, wherein said polysaccharide contains acid groups.

18. The inkjet ink set of claim 16, wherein said polysaccharide contains primary hydroxyl groups.

19. The inkjet ink set of claim 12, wherein said hydrophilic polymer is DNA.

20. The inkjet ink set of claim 12, wherein said pigment colorant is a self-dispersing pigment.
